(19) United States
(12) Patent Application Publication
(10) Pub. No.: US 2022/0320658 A1
(43) Pub. Date: Oct. 6, 2022

(54) Housing, Battery Cell and Method for Producing a Housing of a Battery Cell

(71) Applicant: Bayerische Motoren Werke Aktiengesellschaft, Muenchen (DE)

(72) Inventors: Lilo DIEGELMANN, Unterhaching (DE); Jochen FRIEDL, Pfaffenhofen (DE); Simon LUX, Muenchen (DE); Matthias SCHROEDER, Muenchen (DE)

(21) Appl. No.: 17/596,004

(22) PCT Filed: Jul. 14, 2020
(86) PCT No.: PCT/EP2020/069829

§ 371 Date: Dec. 1, 2021

(30) Foreign Application Priority Data
Aug. 12, 2019 (DE) 10 2019 121 681.8

(51) Int. Cl. H01M 50/231; H01M 50/227; H01M 50/224; B32B 15/08; B32B 15/20

(52) U.S. Cl. CPC H01M 50/231; H01M 50/227; H01M 50/224; B32B 15/08; B32B 15/20; B32B 2457/10; B32B 2250/02

(57) ABSTRACT

A housing, in particular a battery housing, includes a wall, wherein the wall is formed, at least is some areas, from a multi-layered material. The wall encompasses an arrangement area which is formed by bending the material.

### BACKGROUND AND SUMMARY OF THE INVENTION

The present invention relates to a housing, in particular a battery housing, to a battery cell, to the use of a composite aluminum plate and to a method for producing a housing of a, or for, a battery cell.

Electrical energy storage units, for example battery cells, such as lithium-ion cells, as are used in traction batteries of motor vehicles, generally have metallic housings.

DE 10 2012 213 868 A1 discloses, for example, a battery with a metallic housing, wherein an outer surface of the metallic housing has an insulating coating which is applied in single-layered or multi-layered form and connected firmly to the metallic outer surface of the battery. The cell housing can be insulated for example by means of the following methods: pneumatic atomization of a coating, dip coating, web-fed printing, pad printing or screen printing, electrostatic spraying, thermal spraying with inorganic constituents or electrolytic oxidation with subsequent after-densification and/or sealing. The actual housing shape is realized by deep drawing, for example. Overall, this leads to a very expensive and complex production process.

It is an object of the present invention to provide a housing, a battery cell, the use of a composite aluminum plate and a method for producing a housing of a, or for, a battery cell which develop the known solution approaches and lead in particular to a simplification of the method and reduction in costs in the production of housings of electrical storage units.

This object is achieved by a housing, by a battery cell, by the use and by a method, in accordance with the independent claims. Further advantages and features emerge from the dependent claims and the description and the attached figures.

According to the invention, a housing, in particular a battery housing, or more generally a storage unit housing for electrical energy, comprises a wall, wherein the wall is formed at least in certain regions, also completely according to one embodiment, from a multi-layered material, and wherein the wall encloses an arrangement space which is formed by bending the material. In this case, the expression “bending” preferably includes, inter alia, folding, kinking, chamfering and/or rolling of the material to form the desired shape.

The material is expediently in the form of a plate-shape or sheet-shape starting material. This starting material is advantageously brought into the desired shape by means of bending, in the case of a prismatic housing, for example for a lithium-ion cell, in particular by means of folding or chamfering or, as in the case of a round cell, in particular by means of rolling.

The multi-layered material is expediently a laminate, comprising at least two plies, wherein a first ply is based on a metallic material or on a metal, in particular on an aluminum material, and wherein a second ply is based on a plastics material. The required electrical insulation of the cell housing is thus expediently already provided in the starting material. In particular, the second ply serves to provide a desired electrical insulating effect. After the actual housing geometry has been formed, no further insulating step is expediently required. A plurality of first plies and/or also second plies are further preferably provided.

In this case, the bending process per se can be carried out so carefully that the insulation is also not destroyed or damaged during the forming operation.

According to one embodiment, the laminate comprises a different number of layers or plies in certain regions or portions. As a result, it is for example possible to provide a housing whose base is formed exclusively from metal or from a metallic ply, in particular from the first ply. The multi-layered material may thus also comprise only one ply in certain regions. The different number of layers or plies can already be taken into consideration during the production of the starting material. Alternatively, it is also possible for one or more plies to subsequently be removed in certain regions or portions.

According to one embodiment, the housing is not formed completely from the multi-layered material. The base is left out, for example, and is formed by a subsequently arranged component, such as for example a metal plate, in particular an aluminum plate.

According to one embodiment, the wall is designed such that an inner ply adjoining the arrangement space is the first ply, and an outwardly directed outer ply is the second ply. In other words, according to one embodiment, the aluminum ply is directed inward, while the plastics ply is directed outward.

A further advantage to be mentioned is that the bending can be implemented both by machine and by hand. In this respect, a housing of this kind, and the method mentioned later, is optimally suitable both for prototyping and for series production.

According to a preferred embodiment, the material or the starting material is a composite aluminum plate. According to a preferred embodiment, the composite aluminum plate comprises three layers, wherein the outer plies or outer layers are composed of aluminum or are based on an aluminum material, and an intermediate ply arranged in between is based on a plastics material, such as for example polyethylene (PE) or polypropylene (PP), or a mixture of the aforementioned materials. Alternative plastics or composite materials which are for example designed to provide an, in particular electrical, insulating effect are likewise preferred. Typical wall thicknesses of preferred composite plates lie for example in a range of approximately 0.3 to 2.5 mm, in particular in a range of approximately 0.5 to 1.5 mm, this denoting an overall thickness. Preferred composite materials are also known under the (trade) name “Dibond”.

The composite plate can expediently be formed by means of chamfering to form a housing. Processing is performed, for example, with the aid of a bending bench, a bending press, a roller round bending machine, etc. According to one embodiment, prior to the folding or bending, or chamfering, a recess, such as for example a groove, preferably a V-shaped groove, is introduced along the fold or bend line in order to be able to obtain a narrow bend or edge radius and to not damage the starting material, which is relatively stiff.

Alternatively, the composite plate comprises two layers, for example an aluminum layer and a plastics layer, or more than three layers.

The composite material is expediently a starting material which has a degree of stability or strength. The starting material is in plate-shape form, for example. Alternatively, a composite or layered material, such as for example a film, can also be used as starting material, which is brought into a fixed or permanent shape only after the bending operation, for example by suitable action of temperature.

The bending itself may also take place under the influence of temperature, in order to make the bending per se easier or to simplify the process and/or to conserve the material during the forming operation.

According to one embodiment, the wall has at least one joint, wherein one or more plies of the material are connected/joined, in particular in a materially bonded manner, at the joint. The at least one joint lies, in the case of a prismatic housing, in particular at an edge of the housing. In this case, the joining process can be configured differently in dependence on the plies to be connected. By way of example, the aluminum plies are connected by means of welding, while the plastics plies are adhesively bonded. Alternatively, it is also possible for all of the plies to be adhesively bonded to one another. A prismatic housing has four joints, for example, these joints being formed, when the housing is being erected, at the vertically extending edges.

The plies in the wall, in particular also over the joints, are preferably configured so as to be closed in a continuous/encircling manner. In particular, a reliable and encircling insulating effect can thus be provided.

According to one embodiment, the material is joined for example in a mitered manner at the at least one joint. Alternatively, the plies can also bear against one another in abutting fashion. As already mentioned, the at least one joint or the joints is/are provided in particular in the edges or edge regions of the subsequent housing. Alternatively, they may also be provided in the surface regions, that is to say in particular on the side walls or on the base element.

According to one embodiment, the housing comprises a cover element, which is designed to close an opening of the housing, wherein the cover element is formed from the multi-layered material, in particular from the same material as the rest of the housing. The cover element comprises for example the poles of the subsequent battery cell.

According to one embodiment, the cover element bears against the opening in a form-fitting manner in such a way that the plies of the material are closed in a continuous/encircling manner. It is thereby expediently possible to obtain an optimal insulating effect.

According to one embodiment, such as for example in the case of a round cell, it is also possible to provide a plurality of cover elements in order to provide a closed arrangement space.

The invention is also directed to a battery cell comprising a housing according to the invention.

According to a preferred embodiment, the housing is a prismatic battery or cell housing. However, alternative geometries which deviate therefrom are contemplated at any time, in particular facilitated by the very flexible bending process. Size adaptation or variation can also be realized in a very rapid manner.

According to one embodiment, plies/layers of the wall are connected to different potentials of the battery. According to one embodiment, a metallic inner ply is set to the potential of the positive (or negative) terminal, wherein a metallic outer ply is set to terminal voltage or OCV (open-circuit voltage). A plastics ply is preferably arranged as intermediate ply, in particular for insulating purposes. In this way, sensory deficits can advantageously be shown.

The invention is also directed to the use of a composite aluminum plate to produce a housing for an electrical energy storage unit, in particular a lithium-ion cell.

The invention is furthermore directed to a method for producing a housing of a battery cell, comprising the steps of:

providing a multi-layered material; and
forming an arrangement space by bending the material.

The advantages and features mentioned in conjunction with the housing and the battery cell also apply analogously and correspondingly to the use and to the method, and vice versa and with respect to one another. In particular, the bending involves folding, chamfering, kinking and/or rolling. The bending, such as for example the folding, of the starting material, such as a composite plate, offers the possibility of ensuring an in particular very homogeneous and defined insulation layer. Consequently, a very high level of manufacturing precision can be realized. In addition, the flexibility of the method in relation to the cell size should be mentioned. For example, during conventional methods, such as deep drawing or extrusion, very high tooling costs are produced when a cell geometry is changed, and this can be realized very easily in the case of bending.

According to one embodiment, the method comprises the step of: introducing fold lines and/or slits into the material prior to the forming of the wall.

According to one embodiment, recesses, for example in the form of grooves, are introduced into the starting material along the fold or bend lines. This is advantageous particularly in the case of solid materials/starting materials, such as composite plates, since narrow bend radii can thus be obtained. In addition, the material is conserved during the forming operation. Particular preference is given to V-shaped grooves if the subsequent wall forms a 90° angle.

Further advantages and features emerge from the following description of embodiments with reference to the attached figures. Here, different features can be combined with one another in the context of the invention.

### BRIEF DESCRIPTION OF THE DRAWINGS

FIG. 1 shows three embodiments of materials, bent to form housings;

FIG. 2 shows a schematic depiction of one embodiment of a housing;

FIG. 3 shows a further schematic depiction of one embodiment of a housing;

FIG. 4 shows a schematic view of one embodiment of a starting material prior to the bending to form a housing, and also corresponding detail views;

FIG. 5 shows a further embodiment of a starting material; and

FIG. 6 shows a further embodiment of a starting material.

### DETAILED DESCRIPTION OF THE DRAWINGS

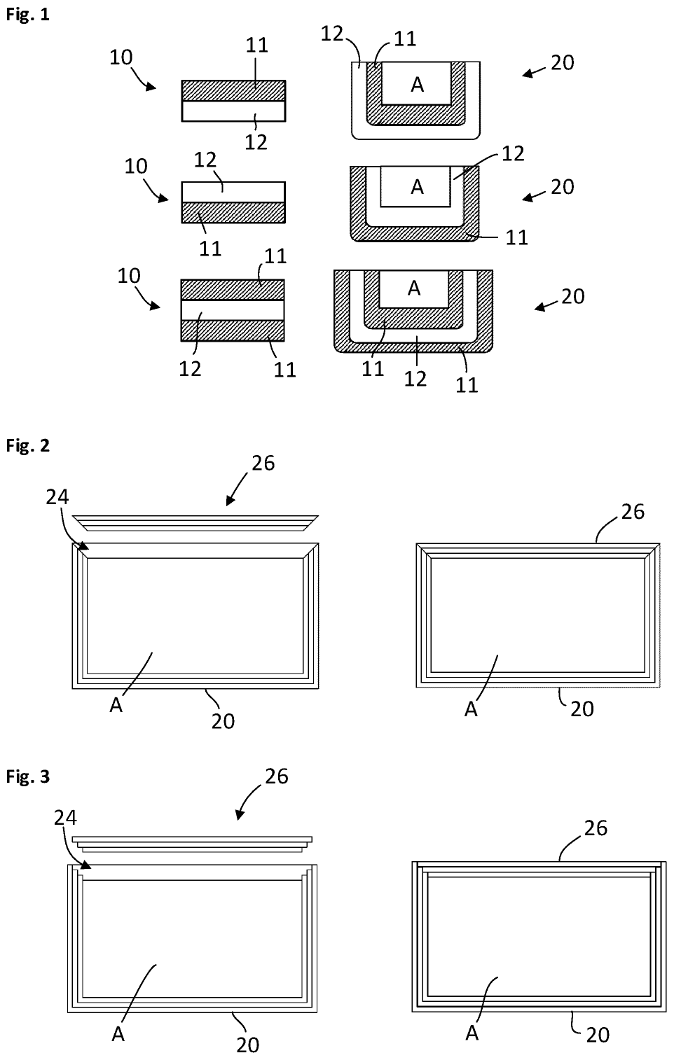

FIG. 1 shows, in the left-hand image half, three different embodiments of materials 10 or starting materials. The materials 10 are each of multi-layered form. A first ply 11 is formed for example from aluminum or an aluminum alloy. A second ply 12 is formed for example from a plastics material, such as PP or PE. The materials 10 or the starting materials are bent to form housings, as are depicted in the right-hand image half. Reference designation 20 in this case denotes the wall of the respective housing. Arrangement spaces A are provided for the arrangement of the electrical components of the battery cell, such as the electrodes, etc. The uppermost variant on the right shows one embodiment in which the wall 20 has an aluminum ply on its inner side and an insulation ply on the outer side. This configuration is optimal particularly for lithium-ion cells. Alternatively, it is also possible to realize an embodiment as illustrated in the middle on the right. Further alternatively, particular preference is given to a three-layered or multi-layered starting material, such as for example a composite aluminum plate, see the embodiment at the bottom or at the bottom right. For example, the metallic plies are preferably set to different potentials of the battery cell.

FIG. 2 shows a further embodiment of a housing, comprising a wall 20 composed of a multi-layered material, in particular composed of a three-layered material, wherein the wall 20 encloses an arrangement space A. The wall 20 also forms an opening 24, wherein said opening is closed or can be closed by means of a cover element 26. The right-hand image half shows a closed illustration. FIG. 2 shows in particular that the cover element 26 is advantageously formed from the same starting material or from the same material as the wall 20 of the housing itself. In this case, the opening 24 and the cover element 26 are formed congruently with respect to one another such that the plies are configured so as to be closed in an encircling manner in the closed state of the housing, see the right-hand image half.

FIG. 3 shows a further embodiment of a housing, wherein the essential features are known from FIG. 2. Here, it is merely a contact point between an opening 24 of the wall 20 and the cover element 26 that is configured differently. Here, the individual plies bear against one another in abutting fashion and not in a mitered manner or at a 45° angle as in FIG. 2. However, the advantageous, encircling ply structure can also be realized in this way.

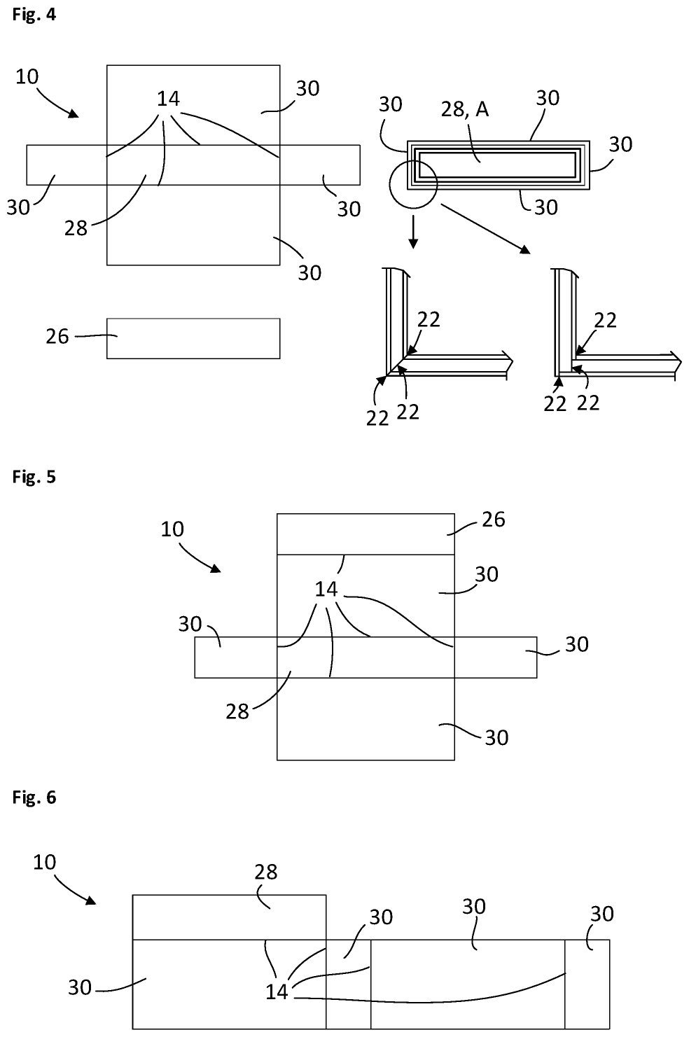

FIG. 4 shows, in its left-hand image half, one embodiment 10 of an, in particular plate-like, material 10. Here, a starting material has already been cut to size such that all the parts of the subsequent housing can be seen. These are, in particular, a base 28 and corresponding side walls 30 of the subsequent housing. Reference designation 14 denotes bend or fold lines along which the material 10 is folded in a subsequent method step. A cover element 26 has already been cut out, too. If the material 10 or the starting material is then bent via the fold lines 14, that is to say in particular the side walls 30 are bent upward, in particular “folded” in the embodiment illustrated here, through 90° out of the plane of the drawing, a housing as illustrated at the top in the right-hand image half is advantageously produced. Here, a plan view of the housing is illustrated. The cover element 26 has not yet been arranged, with the result that an arrangement space A is visible. In the present case, the starting material has been formed to form a prismatic housing, which has four vertically extending edges. In the present case, the material 10 is connected/joined at the edges. The circle focuses on one of the edges of the housing: what is illustrated is that an edge may have a plurality of joints 22, to which the various plies of the material 10 are connected, in particular joined. In particular, the individual plies of the material 10 may be joined to one another. Preference is given for example to joining methods which produce a material bond, for example welding or adhesive bonding, depending on the material. The left-hand example shows that the material bears against the edge in a mitered manner, while said material is joined in abutting fashion in the right-hand image half. In both cases, however, the plies of the material are maintained in a continuous or encircling form, such that for example an insulating effect optimally remains unchanged. The starting material may be formed such that the base 28 comprises only one ply, in particular for example a metallic ply. The housing consequently has a metal base.

FIG. 5 shows a further embodiment of a material 10 or a starting material, wherein, here, a folding arrangement is constructed differently to in FIG. 4. In particular, in this embodiment, the material 10 or the starting material also comprises a cover element 26, which is virtually not in the form of a separate part.

FIG. 6 shows a further embodiment of a material 10 or a starting material and shows a further bending or folding arrangement. Reference designation 28 denotes a base, which is connected via a fold line to a side wall 30. Arranged on this side wall 30 are the further side walls 30 which, after a corresponding bending or folding process, are then each connected to the base 28. Here, the great flexibility of the manufacturing method becomes apparent.

### LIST OF REFERENCE DESIGNATIONS

10 Material
11 First ply
12 Second ply
13 Third ply
14 Fold line
20 Wall
22 Joint
24 Opening
26 Cover element
28 Base
30 Side wall
60 Arrangement space

1.-15. (canceled)

16. A battery housing, comprising:
a wall,
wherein the wall is formed at least in certain regions from a multi-layered material, and
wherein the wall encloses an arrangement space, which arrangement space is formed by bending the multi-layered material.

17. The housing according to claim 16, wherein
the multi-layered material is in a form of a plate-shaped or sheet-shaped starting material.

18. The housing according to claim 16, wherein
the multi-layered material is a laminate, comprising at least two plies,
a first ply is based on a metallic material, and
a second ply is based on a plastics material.

19. The housing according to claim 18, wherein
the metallic material is aluminum.

20. The housing according to claim 18, wherein
the wall is configured such that an inner ply adjoining the arrangement space is the first ply, and an outwardly directed outer ply is the second ply.

21. The housing according to claim 16, wherein
the material is a composite aluminum plate.

22. The housing according to claim 18, wherein
the wall has at least one joint, and
one or more plies of the material are connected/joined in a materially bonded manner at the at least one joint.

23. The housing according to claim 18, wherein
the plies in the wall are configured so as to be closed in a continuous/encircling manner.

24. The housing according to claim 22, wherein
the material is joined in a mitered manner at the at least one joint.

25. The housing according to claim 16, further comprising:
a cover which is configured to close an opening of the housing,
wherein the cover is formed from the multi-layered material.

26. The housing according to claim 25, wherein
the cover bears against the opening in a form-fitting manner such that the plies of the material are closed in a continuous/encircling manner.

27. A battery cell comprising a housing according to claim 16.

28. The battery cell according to claim 27, wherein
plies of the wall are connected to different potentials of the battery cell.

29. A method for producing a housing of a battery cell, the method comprising the steps of:
providing a multi-layered material; and
forming an arrangement space by bending the multi-layered material.

30. The method according to claim 29, further comprising the step of:
introducing fold lines and/or slits into the multi-layered material prior to forming a wall of the housing by bending the multi-layered material to form the arrangement space.

31. The method according to claim 28, the method uses a composite aluminum plate as the multi-layered material.
